(19) United States
(12) Patent Application Publication
(10) Pub. No.: US 2026/0039235 A1
(43) Pub. Date: Feb. 5, 2026

(54) CURRENT COMMAND MODIFICATION TO COMPENSATE FOR TORQUE ERROR DUE TO TEMPERATURE CHANGE IN ALTERNATING CURRENT ELECTRIC MACHINES

(71) Applicant: GM GLOBAL TECHNOLOGY OPERATIONS LLC, DETROIT, MI (US)

(72) Inventors: Anmol Aggarwal, Waterford, MI (US); Vinod Chowdary Peddi, Shelby Township, MI (US)

(21) Appl. No.: 18/792,731

(22) Filed: Aug. 2, 2024

(51) Int. Cl. H02P 29/66; B60L 15/20; H02P 23/14

(52) U.S. Cl. CPC H02P 29/66; B60L 15/2045; H02P 23/14; B60L 2240/425

(57) ABSTRACT

Examples described herein provide a method for current correction of an electric motor of a vehicle operating at an operating temperature. The method includes locating an operating point (Is-β) for a nominal temperature. The method further includes identifying a corresponding torque (Te) and flux (λs) at the nominal temperature and an estimated rotor temperature (Tᵣₒₜₒᵣ). The method further includes identifying a solution for torque (Te) and flux (λs) at the estimated rotor temperature (Tᵣₒₜₒᵣ). The method further includes controlling, using a current correction based on the solution, the electric motor of the vehicle to improve the operation of the electric motor at the operating temperature.

### BACKGROUND

The subject disclosure relates to vehicles, and in particular to providing a current command modification to compensate for torque error due to temperature change in alternating current electric machines.

Modern vehicles (e.g., a car, a motorcycle, a boat, or any other type of automobile) may be equipped with one or more alternating current (AC) electric machines. An AC electric machine refers to an electric motor that operates using alternating current. AC electric machines are useful in electric vehicles (EVs) and hybrid electric vehicles (HEVs), for example, due to their efficiency, improved performance capabilities, ability to regenerate energy during breaking (regenerative breaking), ease of control, and ability to operate over a wide range of speeds. For example, AC electric machines in EVs drive the wheels directly or through a transmission system. In HEVs, AC electric machines can be used in combination with internal combustion engines to provide additional power, improve fuel efficiency, and reduce emissions. Types of AC electric machines include, for example, induction motors and synchronous motors, such as permanent magnet synchronous motors (PMSMs).

### SUMMARY

In one embodiment, a method for current correction of an electric motor of a vehicle operating at an operating temperature is provided. The method includes locating an operating point (Is-β) for a nominal temperature. The method further includes identifying a corresponding torque (Te) and flux (λs) at the nominal temperature and an estimated rotor temperature (Tᵣₒₜₒᵣ). The method further includes identifying a solution for torque (Te) and flux (λs) at the estimated rotor temperature (Tᵣₒₜₒᵣ). The method further includes controlling, using a current correction based on the solution, the electric motor of the vehicle to improve the operation of the electric motor at the operating temperature.

In addition to one or more of the features described herein, or as an alternative, further embodiments of the method may include determining whether the solution exists for a flux value within a current limit for a nominal case.

In addition to one or more of the features described herein, or as an alternative, further embodiments of the method may include, responsive to determining that the solution exists for the flux value within the current limit for the nominal case, identifying the current correction for the torque (Te) and the flux (λs).

In addition to one or more of the features described herein, or as an alternative, further embodiments of the method may include, responsive to determining that the solution does not exist for the flux value within the current limit for the nominal case, identifying the current correction by maximizing the torque (Te) for the flux value.

In addition to one or more of the features described herein, or as an alternative, further embodiments of the method may include that maximizing the torque is performed using the following equation:

$$max ( {T}_{e}^{{T}_{r o t o r}} ( {I}_{d} , {I}_{q} ) ) \&\& \vert {λ}_{s}^{{T}_{r o t o r}} ( {I}_{d} , {I}_{q} ) - {λ}_{s} \vert < {ε}_{F}$$

where

$${T}_{e}^{{T}_{r o t o r}}$$

is the torque at the estimated rotor temperature (Tᵣₒₜₒᵣ), I_{d} and I_{q} are d-axis and q-axis currents respectively,

$${λ}_{s}^{{T}_{r o t o r}}$$

is the flux at the estimated rotor temperature (Tᵣₒₜₒᵣ), λ_{S} is the flux at the nominal temperature, and ϵ_{F} is a tolerance allowed for a flux error.

In addition to one or more of the features described herein, or as an alternative, further embodiments of the method may include that the nominal temperature differs from the estimated rotor temperature (Tᵣₒₜₒᵣ).

In addition to one or more of the features described herein, or as an alternative, further embodiments of the method may include that the method is performed as an online process while the electric motor is operating.

In addition to one or more of the features described herein, or as an alternative, further embodiments of the method may include that the method is performed as an offline process while the electric motor is not operating, and the current correction can be later used when the electric motor is in operation.

In addition to one or more of the features described herein, or as an alternative, further embodiments of the method may include that identifying the solution for torque (Te) and flux (λs) at the estimated rotor temperature (Tᵣₒₜₒᵣ) uses the following equation:

$$\vert {T}_{e}^{{T}_{r o t o r}} ( {I}_{d} , {I}_{q} ) - {T}_{e} \vert < {ε}_{T} \&\& \vert {λ}_{s}^{{T}_{r o t o r}} ( {I}_{d} , {I}_{q} ) - {λ}_{s} \vert < {ε}_{F}$$

where

$${T}_{e}^{{T}_{r o t o r}}$$

is the torque at the estimated rotor temperature (Tᵣₒₜₒᵣ), I_{d} and I_{q} are d-axis and q-axis currents respectively, Te is the torque at the nominal temperature, ϵ_{T} is a tolerance allowed for a torque error,

$${λ}_{s}^{{T}_{r o t o r}}$$

is the flux at the estimated rotor temperature (Tᵣₒₜₒᵣ), λ_{S} is the flux at the nominal temperature, and ϵ_{F} is a tolerance allowed for a flux error.

In another embodiment, a vehicle is provided. The vehicle includes an electric motor operating at an operating temperature and a processing system. The processing system includes a memory having computer readable instructions and a processing device for executing the computer readable instructions. The computer readable instructions control the processing device to perform operations for current correction of the electric motor of the vehicle operating at the operating temperature. The operations include locating an operating point (Is-β) for a nominal temperature. The operations further include identifying a corresponding torque (Te) and flux (λs) at the nominal temperature and an estimated rotor temperature (Tᵣₒₜₒᵣ). The operations further include identifying a solution for torque (Te) and flux (λs) at the estimated rotor temperature (Tᵣₒₜₒᵣ). The operations further include controlling, using a current correction based on the solution, the electric motor of the vehicle to improve the operation of the electric motor at the operating temperature.

In addition to one or more of the features described herein, or as an alternative, further embodiments of the vehicle may include that the operations further include determining whether the solution exists for a flux value within a current limit for a nominal case.

In addition to one or more of the features described herein, or as an alternative, further embodiments of the vehicle may include that the operations further include, responsive to determining that the solution exists for the flux value within the current limit for the nominal case, identifying the current correction for the torque (Te) and the flux (λs).

In addition to one or more of the features described herein, or as an alternative, further embodiments of the vehicle may include that the operations further include, responsive to determining that the solution does not exist for the flux value within the current limit for the nominal case, identifying the current correction by maximizing the torque (Te) for the flux value within the current limit.

In addition to one or more of the features described herein, or as an alternative, further embodiments of the vehicle may include that maximizing the torque is performed using the following equation:

$$max ( {T}_{e}^{{T}_{r o t o r}} ( {I}_{d} , {I}_{q} ) ) \&\& \vert {λ}_{s}^{{T}_{r o t o r}} ( {I}_{d} , {I}_{q} ) - {λ}_{s} \vert < {ε}_{F}$$

where

$${T}_{e}^{{T}_{r o t o r}}$$

is the torque at the estimated rotor temperature (Tᵣₒₜₒᵣ), I_{d} and I_{q} are d-axis and q-axis currents respectively,

$${λ}_{s}^{{T}_{r o t o r}}$$

is the flux at the estimated rotor temperature (Tᵣₒₜₒᵣ), λ_{S} is the flux at the nominal temperature, and ϵ_{F} is a tolerance allowed for a flux error.

In addition to one or more of the features described herein, or as an alternative, further embodiments of the vehicle may include that the nominal temperature differs from the estimated rotor temperature (Tᵣₒₜₒᵣ).

In addition to one or more of the features described herein, or as an alternative, further embodiments of the vehicle may include that the operations are performed as an online process while the electric motor is operating.

In addition to one or more of the features described herein, or as an alternative, further embodiments of the vehicle may include that the operations are performed as an offline process while the electric motor is not operating, and the current correction can be later used when the electric motor is in operation.

In addition to one or more of the features described herein, or as an alternative, further embodiments of the vehicle may include that identifying the solution for torque (Te) and flux (λs) at the estimated rotor temperature (Tᵣₒₜₒᵣ) uses the following equation:

$$\vert {T}_{e}^{{T}_{r o t o r}} ( {I}_{d} , {I}_{q} ) - {T}_{e} \vert < {ε}_{T} \&\& \vert {λ}_{s}^{{T}_{r o t o r}} ( {I}_{d} , {I}_{q} ) - {λ}_{s} \vert < {ε}_{F}$$

where

$${T}_{e}^{{T}_{r o t o r}}$$

is the torque at the estimated rotor temperature (Tᵣₒₜₒᵣ), I_{d} and I_{q} are d-axis and q-axis currents respectively, Te is the torque at the nominal temperature, ϵ_{T} is a tolerance allowed for a torque error,

$${λ}_{s}^{{T}_{r o t o r}}$$

is the flux at the estimated rotor temperature (Tᵣₒₜₒᵣ), λ_{S} is the flux at the nominal temperature, and ϵ_{F} is a tolerance allowed for a flux error.

In another embodiment a computer program product is provided. The computer program product includes a computer readable storage medium having program instructions embodied therewith, the program instructions executable by at least one processor to cause the at least one processor to perform operations for current correction of an electric motor of a vehicle operating at an operating temperature. The operations include locating an operating point (Is-β) for a nominal temperature. The operations further include identifying a corresponding torque (Te) and flux (λs) at the nominal temperature and an estimated rotor temperature (Tᵣₒₜₒᵣ). The operations further include identifying a solution for torque (Te) and flux (λs) at the estimated rotor temperature (Tᵣₒₜₒᵣ). The operations further include controlling, using a current correction based on the solution, the electric motor of the vehicle to improve the operation of the electric motor at the operating temperature.

In addition to one or more of the features described herein, or as an alternative, further embodiments of the computer program product may include that the operations further include determining whether the solution exists for a flux value within a current limit for a nominal case, and responsive to determining that the solution exists for the flux value within the current limit for the nominal case, identifying the current correction for the torque (Te) and the flux (λs).

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle having a processing system for providing a current command modification to compensate for torque error due to temperature change in an AC electric machine according to one or more embodiments;

FIG. 2 is a block diagram of the processing system of FIG. 1 for providing a current command modification to compensate for torque error due to temperature change the AC electric machine of FIG. 1 according to one or more embodiments;

FIG. 3 is a block diagram of a control scheme according to one or more embodiments;

FIG. 4 is a plot having a torque line, flux ellipse, and operating point according to one or more embodiments;

FIG. 5 is a plot having a change in flux ellipse and a torque line for each of a plurality of temperatures according to one or more embodiments;

FIG. 6 is a flow diagram of a method for providing a current command modification to compensate for torque error due to temperature change in an AC electric machine according to one or more embodiments;

FIG. 7 is a process for current modification according to one or more embodiments;

FIG. 8 is a plot of rotor temperature against a measure of magnet flux strength with respect to nominal temperature according to one or more embodiments;

FIG. 9 is a flow diagram of a method of providing a current command modification to compensate for torque error due to temperature change in an AC electric machine according to one or more embodiments;

FIG. 10 is a block diagram of a control scheme according to one or more embodiments; and

FIG. 11 is a block diagram of a processing system for implementing one or more embodiments described herein.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to providing a current command modification to compensate for torque error due to temperature change in alternating current (AC) electric machines.

Vehicles may include one or more AC electric machines (also referred to as “AC electric motors”) to provide mechanical energy for the vehicles. Certain operating conditions (e.g., cold temperatures and/or hot temperatures) can cause the operation of AC electrical machines to be negatively affected.

One or more embodiments described herein address these and other shortcomings by providing a current command modification to compensate for torque error due to temperature change in alternating current electric machines.

It should be appreciated that the functioning of a vehicle implementing one or more of the embodiments described herein is improved. For example, embodiments described herein provide for determining a current correction for both flux and torque that is used to control the electric motor of the vehicle to improve the operation of the electric motor at the operating temperature. Other benefits and advantages are also apparent to persons having ordinary skill in the art.

FIG. 1 is an illustration of a vehicle 100 having a processing system 102 for providing a current command modification to compensate for torque error due to temperature change in an AC electric machine 104 according to one or more embodiments.

The vehicle 100 can be a car, a truck, a van, a bus, a motorcycle, a boat, or any other type of automobile. According to an embodiment, the vehicle 100 includes an internal combustion engine fueled by gasoline, diesel, or the like. According to another embodiment, the vehicle 100 is a hybrid electric vehicle partially or wholly powered by electrical power. According to another embodiment, the vehicle 100 is an electric vehicle powered by electrical power. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

According to one or more embodiments, the vehicle 100 includes the processing system 102 for providing a current command modification to compensate for torque error due to temperature change in the AC electric machine 104.

The AC electric machine 104 can be any suitable device for providing mechanical energy for the vehicle 100. The AC electric machine 104 receives electrical power and converts the electrical power into mechanical energy that can be used to provide propulsion to the vehicle 100. For example, the AC electric machine 104 can drive wheels 106 of the vehicle 100, directly or through a transmission system, in whole or in part (e.g., in combination with an internal combustion engine).

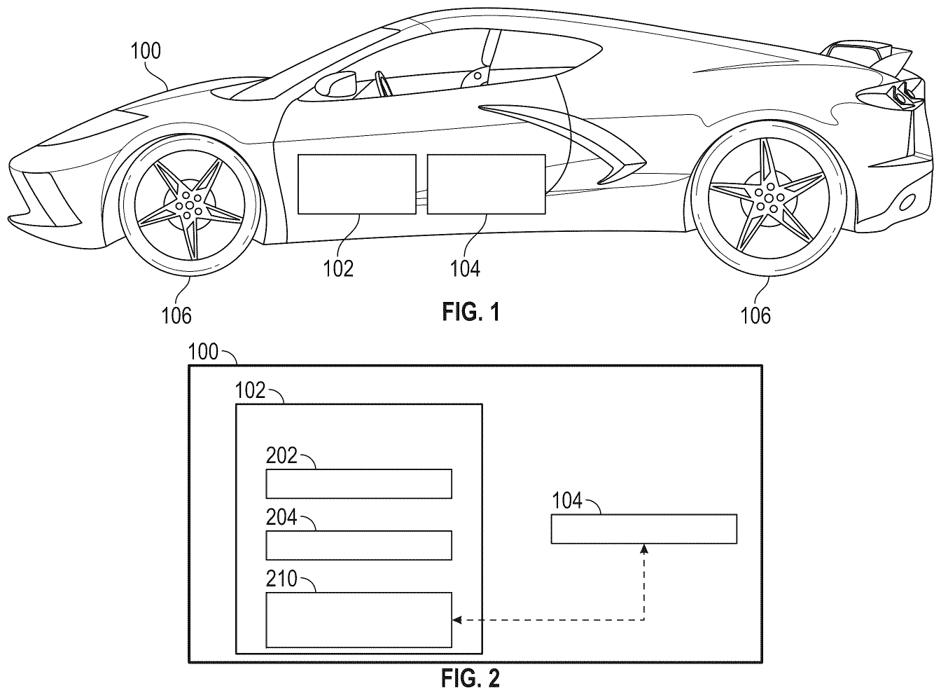

Further features of the processing system 102 are now described with reference to FIG. 2

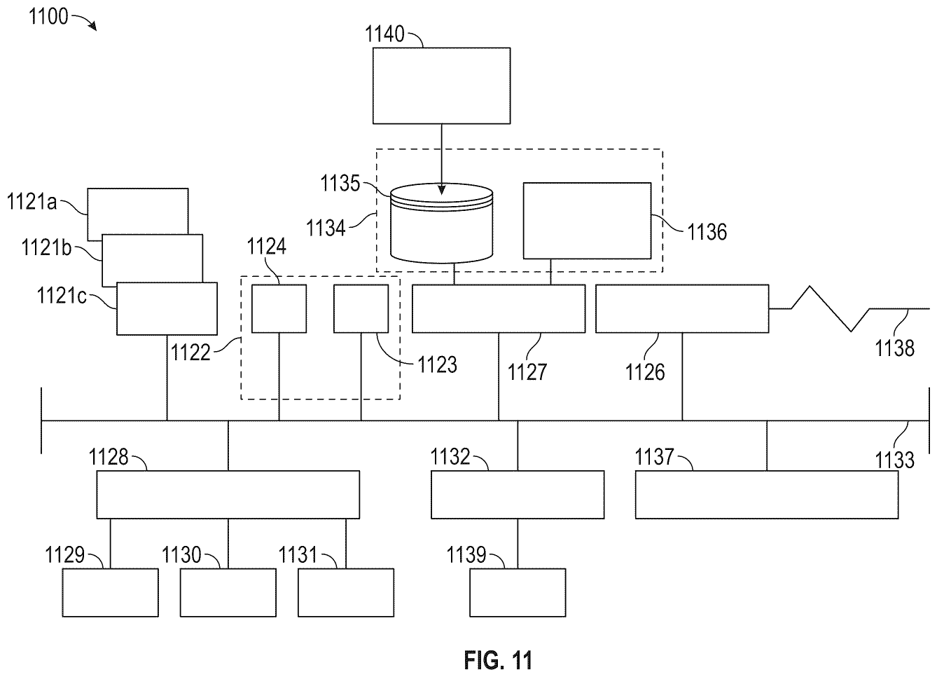

Particularly, FIG. 2 is a block diagram of the processing system 102 of FIG. 1 for providing a current command modification to compensate for torque error due to temperature change in the AC electric machine 104 of FIG. 1 according to one or more embodiments. The processing system 102 includes a processing device 202, a memory 204, and a current command engine 210. It should be appreciated that the processing system 102 can be any device suitable for providing a current command modification to compensate for torque error due to temperature change in the AC electric machine 104. For example, the processing system 102 can be a device implemented in or otherwise associated with the vehicle 100. As another example, the processing system 102 can be a smartphone, tablet computer, laptop computer, desktop computer, wearable computing device, and/or the like, including combinations and/or multiples thereof. As yet another example, the processing system 102 can be the processing system 1100 of FIG. 11 and/or can include one or more components of the processing system 1100 of FIG. 11.

The processing device 202 is any suitable processing circuitry for processing data (e.g., localization data and/or communication data) and/or instructions. The processing device 202 is an example of one or more of the processing devices 1121 of FIG. 11, as described in more detail herein.

The memory 204 is any suitable device for storing data and/or instructions. The memory 204 is an example of one or more of the system memory 1122, the random access memory 1123, and/or the read-only memory 1124 of FIG. 11, as described in more detail herein.

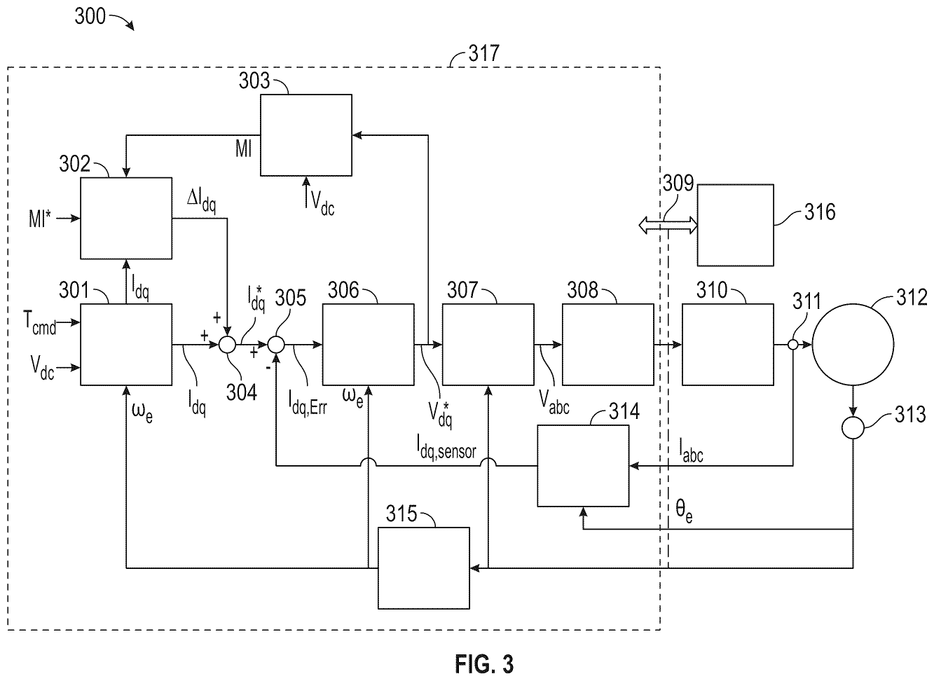

The current command engine 210 determines a current correction of an electric motor (e.g., the AC electric machine 104) of the vehicle 100 operating at an operating temperature that differs from a nominal temperature. Features and functionality of the current command engine 210 are now described in more detail with reference to FIGS. 3-10.

FIG. 3 is a block diagram of a control scheme 300 according to one or more embodiments. In particular, FIG. 3 is a diagram depicting a flow of operations for controlling the electrical system of the vehicle 100. The electrical system includes a hardware portion shown by physical system 316 and a software portion shown by a discrete control system 317, which can be implemented as or using the current command engine 210, as separated by interface 309. The physical system 316 includes an inverter 310 and an electric motor 312 (e.g., the AC electric machine 104). The inverter 310 provides a phase current to the electric motor 312 to control operation of the electric motor 312. In some cases, the phase current is a three-phase current supplied over three phase separate windings (a, b, c) with the currents being out of phase with each other by substantially 120° (or 2π/3). The physical system 316 further includes a current sensor 311 for detecting the phase currents (Iₐ, I_{b}, I_{c}, or I_{abc}) along the phase windings, and a position sensor 313 for detecting a motor position of the electric motor 312, or a position of a rotor within the electric motor 312.

The discrete control system 317 includes algorithm modules for generating a voltage signal that can be used to control operation of the inverter 310. The discrete control system 317 receives current and rotor position data from the physical system 316 and determines a voltage that can be applied to the inverter 310 to achieve desired torque and flux commands. The algorithm modules, which may be implemented by the current command engine 210, include a command generation module 301 (also referred to as torque to current conversion), a current command correction block 302 (also referred to as a flux weakening regulator) to achieve the commanded Modulation Index (MI*), a core current regulator 306 (also referred to as a synchronous current regulator), an inverse-park transform block 307, and a pulse width modulated (PWM) generator module 308 for providing a voltage signal for operating the inverter 310. The command generation module 301 generates a current (I_{dq}), and the current command correction block 302 generates a current difference (ΔI_{dq}), each of which are input to block 304, and the results of block 304 are fed into block 305, which corrects based on a measured current (I_{dq,sensor}), the output of which is fed into the core current regulator 306. Controlling modulation index controls the flux (λ_{S}) in the electric motor 312. The relation between modulation index and flux (λ_{S}) is:

$$MI = \frac{{λ}_{S}}{K \cdot \frac{{V}_{d c}}{{ω}_{m}}} \qquad ( 1 )$$

where K is a constant that depends on number of poles of the electric motor 312 and PWM scheme used for performance, V_{dc} is the direct current (DC) voltage of the battery (not shown) supplied to the inverter 310 and ωₘ is the speed of the electric motor 312 in rad/s. At block 303, the discrete control system 317 calculates the MI online by using the output V_{dq} of the core current regulator 306. The park transform block 314 converts the phase currents I_{abc} into discretized current values in the direct axis (d-axis) and quadrature axis (q-axis) of a rotor of the electric motor 312. The park transform block 314 performs the transformation using the motor position θₑ. The time differentiation module 315 outputs a motor speed de based on measurements of the rotor position of the rotor of the electric motor 312.

According to one or more embodiments, look up tables (LUTs) from torque and MI (λs) command to I_{dq}, as shown in blocks 301, 302, are calibrated at nominal temperature (e.g., 60 degrees Celsius). Therefore, the operation of the electric motor 312 is affected as the machine temperature changes due to changes in the environmental conditions.

According to one or more embodiments, the measured current for the three phases (Iₐ, I_{b}, I_{c}) are transformed to two phases (I_{dg}) and controlled to achieve a desired torque and flux. In this embodiment, the torque (Te) and flux (λs) are the functions of (I_{dq}) along with magnet flux (λpm), machine dq axis inductance Ld/Lq and machine number of poles (P).

The amplitude of the AC current is expressed by the following equation:

$$Amplitude of the AC current ( {I}_{a} or {I}_{b} or {I}_{c} ) = \sqrt{{I}_{d}^{2} + {I}_{q}^{2}} \qquad ( 2 )$$

The torque (Te) is expressed by the following equation:

$$Torque equation : {T}_{e} = \frac{3}{4} P ( {λ}_{p m} {I}_{q} + ( {L}_{d} - {L}_{q} ) {I}_{d} {I}_{q} ) \qquad ( 3 )$$

The flux ellipse is expressed by the following equation:

$$Flux ellipse equation : {λ}_{s}^{2} = \frac{{( {I}_{d} + \frac{{λ}_{pm}}{{L}_{d}} )}^{2}}{\frac{1}{{L}_{d}^{2}}} + \frac{{I}_{q}^{2}}{\frac{1}{{L}_{q}^{2}}} \qquad ( 4 )$$

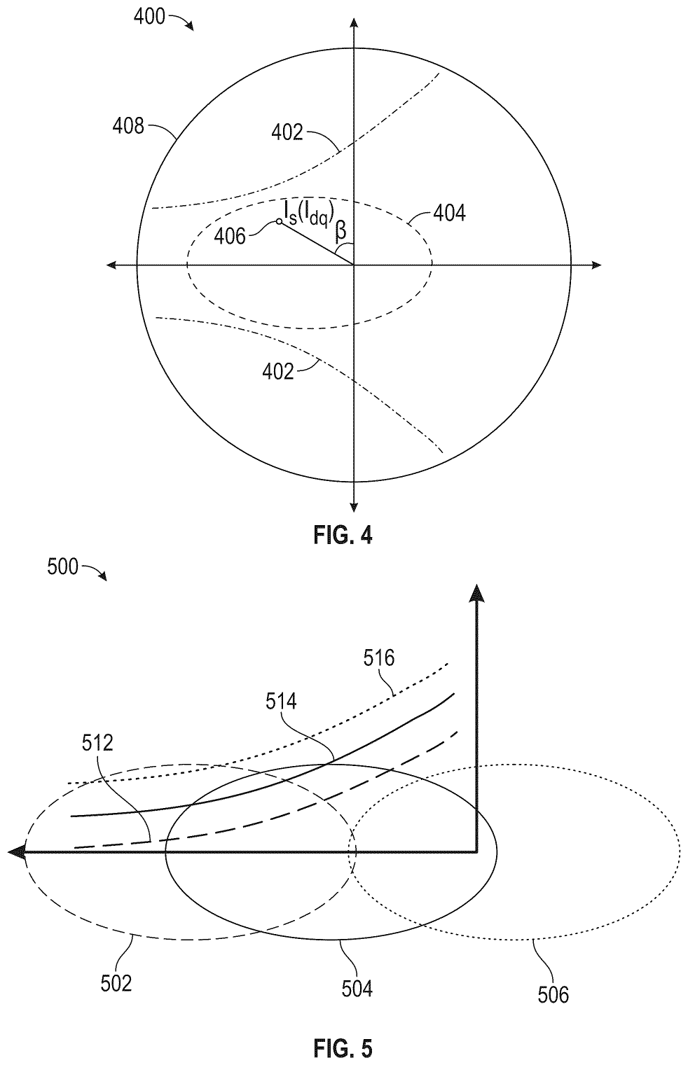

FIG. 4 is a plot 400 having a torque line 402, flux ellipse 404, and operating point 406 according to one or more embodiments. At a given torque and flux, the operating point 406 is defined that satisfies constraints (e.g., efficiency; noise, vibration, harshness (NVH); etc.) that can be represented by a point in the Id-Iq plane. This point in a cartesian coordinate system can be represented by I_{dq} or in a polar coordinate system can be represented by Is-β, where β is measured from the Iq line as shown in FIG. 4

Based on the definitions shown in equations (2) and (3), the torque line 402 and the flux ellipse 404 are shown in FIG. 4, along with a maximum current limit 408. The maximum current limit 408 depends on the physical limits of the inverter or motor. According to one or more embodiments, the maximum current limit 408 is a circle in the Id-Iq plane since the amplitude of any of the three phases is determined using equation (2). It should be appreciated that that any operating point of operation of the electric motor 312 can be presented by Idq or Is-β as shown in FIG. 4 with an example being the operating point 406.

Temperature effects on the physical system 316 in terms of torque and flux are now described. FIG. 5 is a plot 500 having a change in flux ellipse and a torque line for each of a plurality of temperatures according to one or more embodiments. Magnet strength (magnet flux linkage λm) increases as temperature decreases (e.g., in a “cold case” (e.g., substantially 20 degrees Celsius)) or decreases as temperature increases (e.g., in a “hot case” (e.g., substantially 120 degrees Celsius)). The inverse relationship between magnet strength and temperature leads to a change in the torque line (for same value of torque) and flux ellipse (for same value of flux) in the Idq plane. For example, the plot 500 includes three flux ellipses: flux ellipse 502 for a cold case, flux ellipse 504 for a nominal case (e.g., substantially 60 degrees Celsius), and flux ellipse 506 for a hot case. Corresponding torque lines are also shown: torque line 512 corresponds to the flux ellipse 502 of the cold case, torque line 514 corresponds to the flux ellipse 504 of the nominal case, and torque line 516 corresponds to the flux ellipse 506 of the hot case. As temperature changes, the lookup tables of I_{dq} command generation from torque and flux commands at nominal temperature is not accurate. Hence, current correction is needed per operating point and temperature to operate the electric motor 312 at the commanded torque and flux.

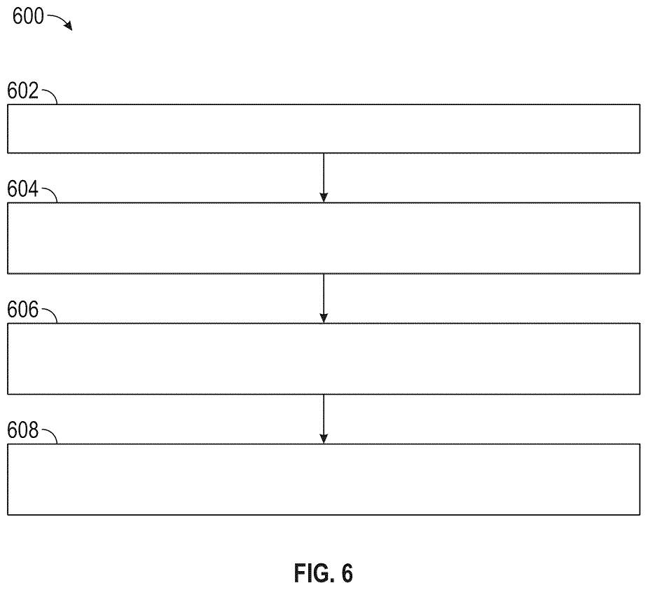

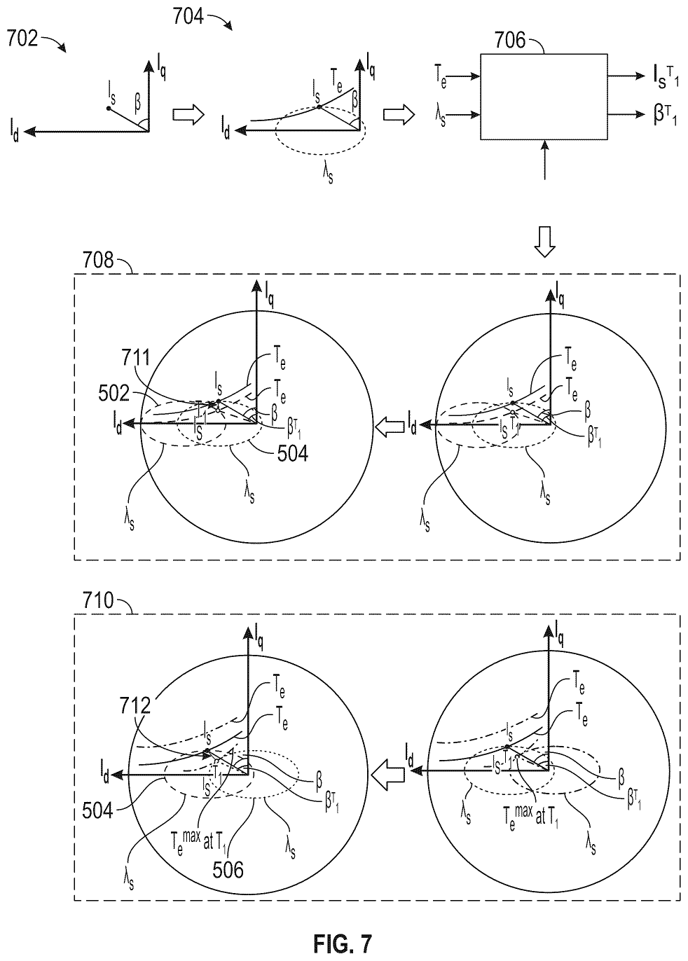

One or more embodiments described herein provide for calculating current command corrections per operating point. Particularly, FIG. 6 is a flow diagram of a method 600 providing a current command modification to compensate for torque error due to temperature change in an AC electric machine according to one or more embodiments. One or more such embodiments can be applied to online compensation or a lookup table can be generated offline, which can be called within the software portion shown by the discrete control system 317. The method 600 can be implemented using any suitable system or device. For example, the method 600 can be implemented using the processing system 102 of FIGS. 1 and 2, by the discrete control system 317 of FIG. 3, by the processing system 1100 of FIG. 11, and/or the like, including combinations and/or multiples thereof. The method 600 is now described with reference to FIG. 7 but is not so limited. Particularly, FIG. 7 is a process for current modification according to one or more embodiments.

At block 602, the method 600 includes locating an operating point (e.g., the operating point 406) (Is-β) for the nominal temperature. An example of locating the operating point is shown in the plot 702 of FIG. 7. At block 604, the method 600 includes identifying a corresponding torque (Te) and flux (λs) at the nominal temperature and estimated rotor temperature (Tᵣₒₜₒᵣ) (also referred to as “operating temperature”). An example of identifying the corresponding torque (Te) and flux (λs) for the operating point is shown in the plot 704 of FIG. 7. At block 606, the method 600 includes identifying a solution for torque (Te) and flux (λs) for block 604 at the estimated rotor temperature (Tᵣₒₜₒᵣ). An example of identifying the solution for torque (Te) and flux (λs) for the estimated rotor temperature is shown in the block 706 of FIG. 7. If a solution exists for the flux value within the maximum current limit for the nominal case (block 708 of FIG. 7), a current correction for both flux and torque (point 711) is identified, which can be used to control the electric motor 312 to improve the operation of the electric motor 312 at the operating temperature. At block 608, if a solution does not exist at block 606, the torque (Te) is maximized for a given flux (λs) within the maximum current limit (block 710 of FIG. 7). This results in a current correction for both flux and torque (point 712) that is used to control the electric motor 312 to improve the operation of the electric motor 312 at the operating temperature. According to one or more embodiments, the method 600 can be an offline process (while the electric motor 312 is not operating) or an online (e.g., real-time or near-real-time) (while the electric motor 312 is operating) process.

Additional processes also may be included, and it should be understood that the processes depicted in FIG. 6 represent illustrations, and that other processes may be added, or existing processes may be removed, modified, or rearranged without departing from the scope of the present disclosure. It should also be understood that the processes depicted in FIG. 6 may be implemented as programmatic instructions stored on a non-transitory computer-readable storage medium that, when executed by a processor (e.g., the processing device 202 of FIG. 2, the processor(s) 1121 of FIG. 11, and/or the like, including combinations and/or multiples thereof) of a computing system (e.g., the processing system 102 of FIGS. 1 and 2, the processing system 1100 of FIG. 11, and/or the like, including combinations and/or multiples thereof), cause the processor to perform the processes described herein.

Machines, such as the electric motor 312, can be calibrated to determine properties of the machine. The calibration (or characterization) procedure finds a map between I_{dq} and

$${λ}_{d}^{{T}_{0}} ( {I}_{d} , {I}_{q} ) and {λ}_{q}^{{T}_{0}} ( {I}_{d} , {I}_{q} ) ,$$

which is used to find the map for Te/λs. Particularly, equations for calculating torque and flux maps for different rotor temperature using a nominal temperature (T₀) are now described according to one or more embodiments. According to an embodiment, flux is calculated using the following equation:

$${λ}_{s}^{{T}_{0}} ( {I}_{d} , {I}_{q} ) = \sqrt{{λ}_{d}^{{T}_{0}} ( {I}_{d} , {I}_{q} ) \cdot {λ}_{d}^{{T}_{0}} ( {I}_{d} , {I}_{q} ) + {λ}_{q}^{{T}_{0}} ( {I}_{d} , {I}_{q} ) \cdot {λ}_{q}^{{T}_{0}} ( {I}_{d} , {I}_{q} )} \qquad ( 5 )$$

According to an embodiment, torque is calculated using the following equation:

$${T}_{e}^{{T}_{0}} ( {I}_{d} , {I}_{q} ) = \frac{3}{4} \cdot P \cdot ( {λ}_{d}^{{T}_{0}} ( {I}_{d} , {I}_{q} ) \cdot {I}_{q} - {λ}_{q}^{{T}_{0}} ( {I}_{d} , {I}_{q} ) \cdot {I}_{q} ) \qquad ( 6 )$$

In these equations,

$${λ}_{d}^{{T}_{0}} ( {I}_{d} , {I}_{q} ) and {λ}_{q}^{{T}_{0}} ( {I}_{d} , {I}_{q} )$$

are the nominal temperature d and q axis flux linkages respectively which are used to calculate the dq axis flux linkages at rotor temperature

$$( {T}_{1} ) {λ}_{d}^{{T}_{1}} ( {I}_{d} , {I}_{q} ) and {λ}_{q}^{{T}_{1}} ( {I}_{d} , {I}_{q} )$$

using the (Br)coefficient (measure of magnet flux strength with respect to nominal temperature). (Br)coefficient=1 at nominal temperature). The variation of Br coefficient with rotor temperature and equations used for the calculation of

$${λ}_{d}^{{T}_{1}} ( {I}_{d} , {I}_{q} ) and {λ}_{q}^{{T}_{1}} ( {I}_{d} , {I}_{q} ) , and {T}_{e}^{{T}_{1}} ( {I}_{d} , {I}_{q} ) / {λ}_{s}^{{T}_{1}} ( {I}_{d} , {I}_{q} )$$

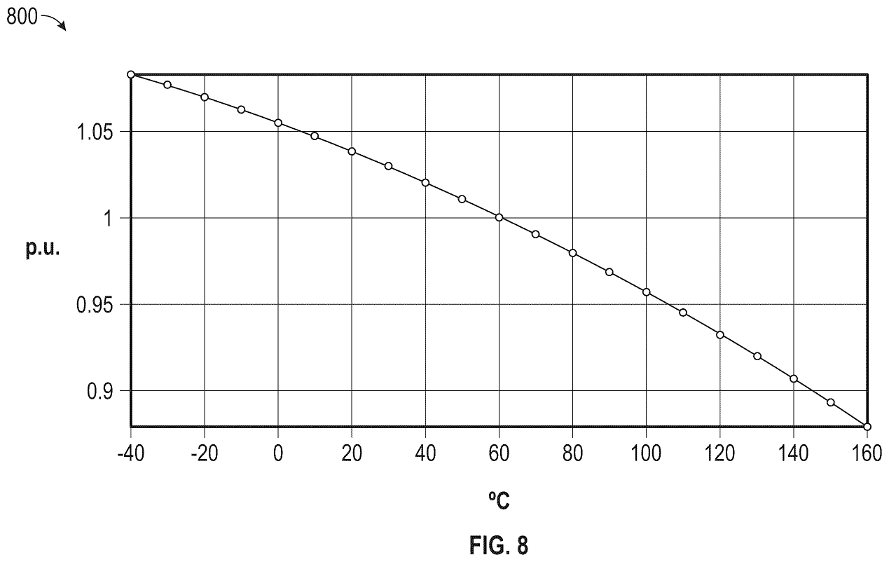

is shown in the plot 800 of FIG. 8, and the equations used for the calculations of torque and flux maps are as follows:

$${λ}_{d}^{{T}_{1}} ( {I}_{d} , {I}_{q} ) = {B}_{r}^{{T}_{1}} \cdot {λ}_{d}^{{T}_{0}} ( 0 , {I}_{q} ) + {L}_{d}^{{T}_{0}} ( {I}_{d} , {I}_{q} ) \cdot {I}_{d} \qquad ( 7 )$$

$${λ}_{q}^{{T}_{1}} ( {I}_{d} , {I}_{q} ) = {λ}_{q}^{{T}_{0}} ( {I}_{d} , {I}_{q} ) \qquad ( 8 )$$

$${λ}_{s}^{{T}_{1}} ( {I}_{d} , {I}_{q} ) = \sqrt{{λ}_{d}^{{T}_{1}} ( {I}_{d} , {I}_{q} ) \cdot {λ}_{d}^{{T}_{1}} ( {I}_{d} , {I}_{q} ) + {λ}_{q}^{{T}_{1}} ( {I}_{d} , {I}_{q} ) \cdot {λ}_{q}^{{T}_{1}} ( {I}_{d} , {I}_{q} )} \qquad ( 9 )$$

$${T}_{e}^{{T}_{1}} ( {I}_{d} , {I}_{q} ) = \frac{3}{4} \cdot P \cdot ( {λ}_{d}^{{T}_{1}} ( {I}_{d} , {I}_{q} ) \cdot {I}_{q} - {λ}_{q}^{{T}_{1}} ( {I}_{d} , {I}_{q} ) \cdot {I}_{q} ) \qquad ( 10 )$$

The plot 800 of FIG. 8 plots rotor temperature in degrees Celsius (x-axis) against the (Br)coefficient (measure of magnet flux strength with respect to nominal temperature.

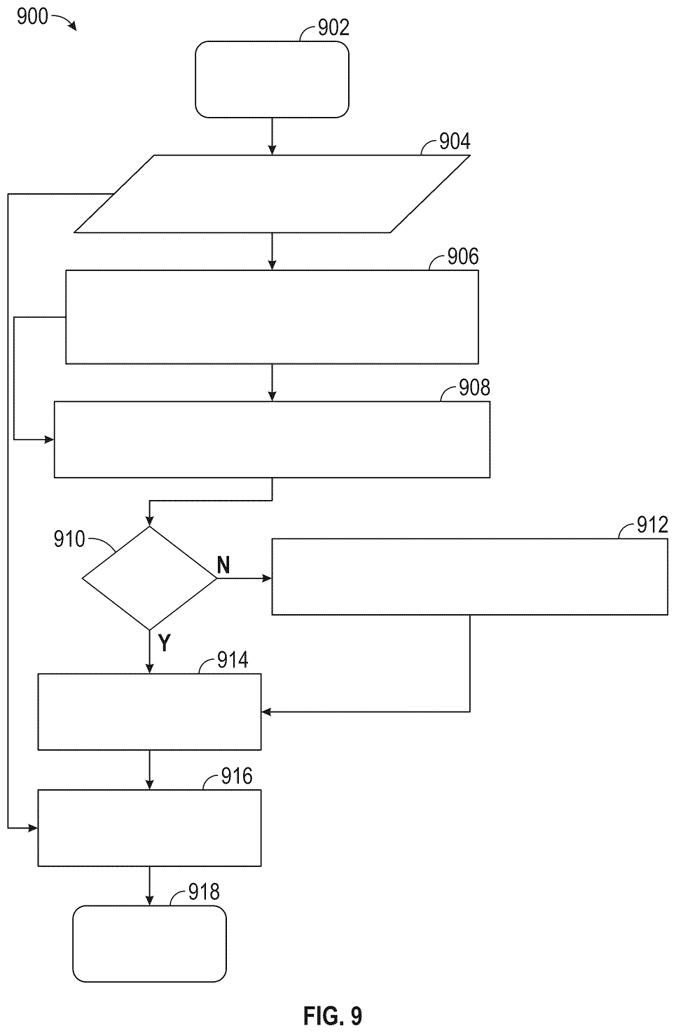

Turning now to FIG. 9, a flow diagram is shown of a method 900 for providing a current command modification to compensate for torque error due to temperature change in an AC electric machine according to one or more embodiments. One or more such embodiments can be applied to online compensation or a lookup table can be generated offline, which can be called within the software portion shown by the discrete control system 317. The method 900 can be implemented using any suitable system or device. For example, the method 900 can be implemented using the processing system 102 of FIGS. 1 and 2, by the discrete control system 317 of FIG. 9, by the processing system 1100 of FIG. 11, and/or the like, including combinations and/or multiples thereof.

At block 902, the method 900 begins. At block 904, the nominal temperature operating point (operating point (Is-β) for a nominal temperature) is obtained. At block 906, a corresponding torque (Te) and flux (λs) at the nominal temperature and an estimated rotor temperature (Tᵣₒₜₒᵣ) are identified or obtained. At block 908, a solution for torque (Te) and flux (λs) at the estimated rotor temperature (Tᵣₒₜₒᵣ) is identified.

At block 910, it is determined whether the solution exists for a flux value within the maximum current limit. If not (block 910 “No”), the method 900 solves for a maximum torque and also solves for flux as described herein at block 912. That is, the current correction is obtained by maximizing the torque (Te) for a flux value within the maximum current limit. Maximizing the torque can be performed using the following equation:

$$max ( {T}_{e}^{{T}_{r o t o r}} ( {I}_{d} , {I}_{q} ) ) \&\& \vert {λ}_{s}^{{T}_{r o t o r}} ( {I}_{d} , {I}_{q} ) - {λ}_{s} \vert < {ε}_{F} \qquad ( 11 )$$

where

$${T}_{e}^{{T}_{r o t o r}}$$

is the torque at the estimated rotor temperature (Tᵣₒₜₒᵣ), I_{d} and I_{q} are the d-axis and q-axis currents respectively,

$${λ}_{s}^{{T}_{r o t o r}}$$

is the flux at the estimated rotor temperature (Tᵣₒₜₒᵣ), λ_{D} is the flux at the nominal temperature, and ϵ_{F} is the allowed tolerance for a flux error.

If it is determined that the solution exists for a flux value of the nominal case (block 910 “Yes”), or subsequent to performing block 912, the method 900 proceeds to block 914, where the current commands for the electric motor 312 is determined for the estimated rotor temperature (Tᵣₒₜₒᵣ).

At block 916, a difference in current (ΔI_{dq}) is determined based on the current command

$$( {I}_{d q}^{{T}_{r o t o r}} )$$

from block 914 and the current at nominal temperature

$$( ( {I}_{d q}^{{T}_{nominal}} )$$

from block 904. This difference can be used to control the electric motor 312 to improve the operation of the electric motor 312 at the operating temperature. The method 900 then proceeds to block 918 and terminates, although in other embodiments, the method 900 may repeat by returning to block 904.

Additional processes also may be included, and it should be understood that the processes depicted in FIG. 9 represent illustrations, and that other processes may be added, or existing processes may be removed, modified, or rearranged without departing from the scope of the present disclosure. It should also be understood that the processes depicted in FIG. 9 may be implemented as programmatic instructions stored on a non-transitory computer-readable storage medium that, when executed by a processor (e.g., the processing device 202 of FIG. 2, the processor(s) 1121 of FIG. 11, and/or the like, including combinations and/or multiples thereof) of a computing system (e.g., the processing system 102 of FIGS. 1 and 2, the processing system 1100 of FIG. 11, and/or the like, including combinations and/or multiples thereof), cause the processor to perform the processes described herein.

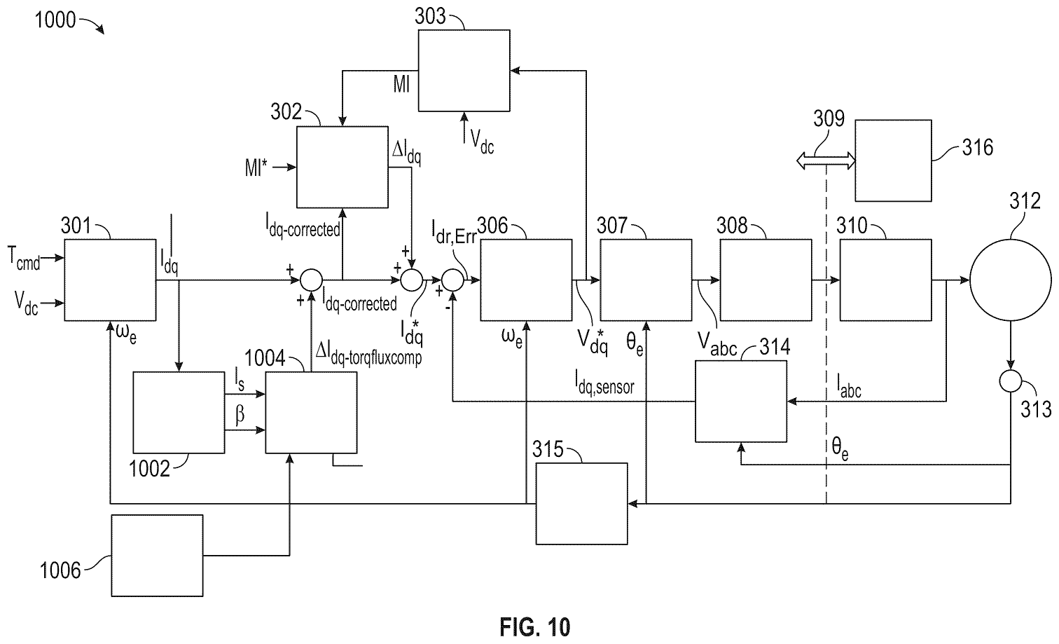

FIG. 10 is a block diagram of a control scheme 1000 according to one or more embodiments. The control scheme 1000 is a modified version of the control scheme 300 of FIG. 3. In FIG. 10, the control scheme 1000 includes the components of the control scheme 300 and further includes blocks 1002, 1004, and 1006, which are now described. Block 1002 receives the current (Idq) for the operating point and determines the operating point (Is-β) for a nominal temperature. The operating point is input into block 1004, where a three-dimensional (3-D) lookup table is calculated using the techniques described herein (e.g., FIG. 9) to generate the difference in current (ΔI_{dq}) for the estimated rotor temperature (Tᵣₒₜₒᵣ) received from the block 1006 (e.g., rotor temperature estimator). The difference in current (ΔI_{dq}) for the estimated rotor temperature (Tᵣₒₜₒᵣ) is used to control the electric motor 312 as described herein.

It is understood that one or more embodiments described herein is capable of being implemented in conjunction with any other type of computing environment now known or later developed. For example, FIG. 11 depicts a block diagram of a processing system 1100 for implementing the techniques described herein. In accordance with one or more embodiments described herein, the processing system 1100 is an example of a cloud computing node of a cloud computing environment. In examples, processing system 1100 has one or more central processing units (referred to also as “processors” or “processing resources” or “processing devices”) 1121a, 1121b, 1121c, etc. (collectively or generically referred to as processor(s) 1121 and/or as processing device(s)). In aspects of the present disclosure, each processor 1121 can include a reduced instruction set computer (RISC) microprocessor. Processors 1121 are coupled to a system memory 1122 and/or various other components via a system bus 1133. The system memory 1122 can include one or more temporary and/or persistent memory devices, such as a random access memory (RAM) 1123, a read-only memory (ROM) 1124, and/or the like, including combinations and/or multiples thereof. The system bus 1133 may include a basic input/output system (BIOS), which controls certain basic functions of processing system 1100.

Further depicted are an input/output (I/O) adapter 1127 and a network adapter 1126 coupled to system bus 1133. I/O adapter 1127 may be a small computer system interface (SCSI) adapter that communicates with a hard disk 1135 and/or a storage device 1136 or any other similar component. I/O adapter 1127, hard disk 1135, and storage device 1136 are collectively referred to herein as mass storage 1134. Operating system 1140 for execution on processing system 1100 may be stored in mass storage 1134. The network adapter 1126 interconnects system bus 1133 with an outside network 1138 enabling processing system 1100 to communicate with other such systems.

A display (e.g., a display monitor) 1139 is connected to system bus 1133 by display adapter 1132, which may include a graphics adapter to improve the performance of graphics intensive applications and a video controller. In one aspect of the present disclosure, adapters 1126, 1127, and/or 1132 may be connected to one or more I/O buses that are connected to system bus 1133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1133 via user interface adapter 1128 and display adapter 1132. A keyboard 1129, mouse 1130, and speaker 1131 may be interconnected to system bus 1133 via user interface adapter 1128, which may include, for example, a Super I/O chip integrating multiple device adapters into a single integrated circuit.

In some aspects of the present disclosure, processing system 1100 includes a graphics processing unit (GPU) 1137. Graphics processing unit 1137 is a specialized electronic circuit designed to manipulate and alter memory to accelerate the creation of images in a frame buffer intended for output to a display. In general, graphics processing unit 1137 is very efficient at manipulating computer graphics and image processing, and has a highly parallel structure that makes it more effective than general-purpose CPUs for algorithms where processing of large blocks of data is done in parallel.

Thus, as configured herein, processing system 1100 includes processing capability in the form of processors 1121, storage capability including the system memory 1122 and mass storage 1134, input means such as keyboard 1129 and mouse 1130, and output capability including speaker 1131 and display 1139. In some aspects of the present disclosure, a portion of system memory 1122 and mass storage 1134 collectively store the operating system 1140 to coordinate the functions of the various components shown in processing system 1100.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for current correction of an electric motor of a vehicle operating at an operating temperature, the method comprising:
locating an operating point (Is-β) for a nominal temperature;
identifying a corresponding torque (Te) and flux (λs) at the nominal temperature and an estimated rotor temperature (Tᵣₒₜₒᵣ);
identifying a solution for torque (Te) and flux (λs) at the estimated rotor temperature (Tᵣₒₜₒᵣ); and
controlling, using a current correction based on the solution, the electric motor of the vehicle to improve the operation of the electric motor at the operating temperature.

2. The computer-implemented method of claim 1, further comprising determining whether the solution exists for a flux value within a current limit for a nominal case.

3. The computer-implemented method of claim 2, further comprising, responsive to determining that the solution exists for the flux value within the current limit for the nominal case, identifying the current correction for the torque (Te) and the flux (λs).

4. The computer-implemented method of claim 2, further comprising, responsive to determining that the solution does not exist for the flux value within the current limit for the nominal case, identifying the current correction by maximizing the torque (Te) for the flux value.

5. The computer-implemented method of claim 4, wherein maximizing the torque is performed using the following equation:
$$max ( {T}_{e}^{{T}_{r o t o r}} ( {I}_{d} , {I}_{q} ) ) \&\& \vert {λ}_{s}^{{T}_{r o t o r}} ( {I}_{d} , {I}_{q} ) - {λ}_{s} \vert < {ε}_{F}$$
where
$${T}_{e}^{{T}_{r o t o r}}$$
is the torque at the estimated rotor temperature (Tᵣₒₜₒᵣ), I_{d} and I_{q} are d-axis and q-axis currents respectively,
$${λ}_{s}^{{T}_{r o t o r}}$$
is the flux at the estimated rotor temperature (Tᵣₒₜₒᵣ), λ_{S} is the flux at the nominal temperature, and ϵ_{F} is a tolerance allowed for a flux error.

6. The computer-implemented method of claim 1, wherein the nominal temperature differs from the estimated rotor temperature (Tᵣₒₜₒᵣ).

7. The computer-implemented method of claim 1, wherein the method is performed as an online process while the electric motor is operating.

8. The computer-implemented method of claim 1, wherein the method is performed as an offline process while the electric motor is not operating, and the current correction can be later used when the electric motor is in operation.

9. The computer-implemented method of claim 1, wherein identifying the solution for torque (Te) and flux (λs) at the estimated rotor temperature (Tᵣₒₜₒᵣ) uses the following equation:
$$\vert {T}_{e}^{{T}_{r o t o r}} ( {I}_{d} , {I}_{q} ) - {T}_{e} \vert < {ε}_{T} \&\& \vert {λ}_{s}^{{T}_{r o t o r}} ( {I}_{d} , {I}_{q} ) - {λ}_{s} \vert < {ε}_{F}$$
where
$${T}_{e}^{{T}_{r o t o r}}$$
is the torque at the estimated rotor temperature (Tᵣₒₜₒᵣ), I_{d} and I_{q} are d-axis and q-axis currents respectively, Te is the torque at the nominal temperature, ϵ_{T} is a tolerance allowed for a torque error,
$${λ}_{s}^{{T}_{r o t o r}}$$
is the flux at the estimated rotor temperature (Tᵣₒₜₒᵣ), λ_{S} is the flux at the nominal temperature, and ϵ_{F} is a tolerance allowed for a flux error.

10. A vehicle comprising:
an electric motor operating at an operating temperature; and
a processing system, the processing system comprising:
a memory comprising computer readable instructions; and
a processing device for executing the computer readable instructions, the computer readable instructions controlling the processing device to perform operations for current correction of the electric motor of the vehicle operating at the operating temperature, the operations comprising:
locating an operating point (Is-β) for a nominal temperature;
identifying a corresponding torque (Te) and flux (λs) at the nominal temperature and an estimated rotor temperature (Tᵣₒₜₒᵣ);
identifying a solution for torque (Te) and flux (λs) at the estimated rotor temperature (Tᵣₒₜₒᵣ); and
controlling, using a current correction based on the solution, the electric motor of the vehicle to improve the operation of the electric motor at the operating temperature.

11. The vehicle of claim 10, wherein the operations further comprise determining whether the solution exists for a flux value within a current limit for a nominal case.

12. The vehicle of claim 11, wherein the operations further comprise, responsive to determining that the solution exists for the flux value within the current limit for the nominal case, identifying the current correction for the torque (Te) and the flux (λs).

13. The vehicle of claim 11, wherein the operations further comprise, responsive to determining that the solution does not exist for the flux value within the current limit for the nominal case, identifying the current correction by maximizing the torque (Te) for the flux value within the current limit.

14. The vehicle of claim 13, wherein maximizing the torque is performed using the following equation:
$$max ( {T}_{e}^{{T}_{r o t o r}} ( {I}_{d} , {I}_{q} ) ) \&\& \vert {λ}_{s}^{{T}_{r o t o r}} ( {I}_{d} , {I}_{q} ) - {λ}_{s} \vert < {ε}_{F}$$
where
$${T}_{e}^{{T}_{r o t o r}}$$
is the torque at the estimated rotor temperature (Tᵣₒₜₒᵣ), I_{d} and I_{q} are d-axis and q-axis currents respectively,
$${λ}_{s}^{{T}_{r o t o r}}$$
is the flux at the estimated rotor temperature (Tᵣₒₜₒᵣ), λ_{S} is the flux at the nominal temperature, and ϵ_{F} is a tolerance allowed for a flux error.

15. The vehicle of claim 10, wherein the nominal temperature differs from the estimated rotor temperature (Tᵣₒₜₒᵣ).

16. The vehicle of claim 10, wherein the operations are performed as an online process while the electric motor is operating.

17. The vehicle of claim 10, wherein the operations are performed as an offline process while the electric motor is not operating, and the current correction can be later used when the electric motor is in operation.

18. The vehicle of claim 10, wherein identifying the solution for torque (Te) and flux (λs) at the estimated rotor temperature (Tᵣₒₜₒᵣ) uses the following equation:
$$\vert {T}_{e}^{{T}_{r o t o r}} ( {I}_{d} , {I}_{q} ) - {T}_{e} \vert < {ε}_{T} \&\& \vert {λ}_{s}^{{T}_{r o t o r}} ( {I}_{d} , {I}_{q} ) - {λ}_{s} \vert < {ε}_{F}$$
where
$${T}_{e}^{{T}_{r o t o r}}$$
is the torque at the estimated rotor temperature (Tᵣₒₜₒᵣ), I_{d} and I_{q} are d-axis and q-axis currents respectively, Te is the torque at the nominal temperature, ϵ_{T} is a tolerance allowed for a torque error,
$${λ}_{s}^{{T}_{r o t o r}}$$
is the flux at the estimated rotor temperature (Tᵣₒₜₒᵣ), λ_{S} is the flux at the nominal temperature, and ϵ_{F} is a tolerance allowed for a flux error.

19. A computer program product comprising a computer readable storage medium having program instructions embodied therewith, the program instructions executable by at least one processor to cause the at least one processor to perform operations for current correction of an electric motor of a vehicle operating at an operating temperature, the operations comprising:
locating an operating point (Is-β) for a nominal temperature;
identifying a corresponding torque (Te) and flux (λs) at the nominal temperature and an estimated rotor temperature (Tᵣₒₜₒᵣ);
identifying a solution for torque (Te) and flux (λs) at the estimated rotor temperature (Tᵣₒₜₒᵣ); and
controlling, using a current correction based on the solution, the electric motor of the vehicle to improve the operation of the electric motor at the operating temperature.

20. The computer program product of claim 19, wherein the operations further comprise:
determining whether the solution exists for a flux value within a current limit for a nominal case; and
responsive to determining that the solution exists for the flux value within the current limit for the nominal case, identifying the current correction for the torque (Te) and the flux (λs).
